(19) United States
(12) Patent Application Publication
(10) Pub. No.: US 2022/0218124 A1
(43) Pub. Date: Jul. 14, 2022

(54) A Conveyor System for a Checkout Counter

(71) Applicant: ITAB Shop Products AB, Jönköping (SE)

(72) Inventors: Fredrik Engholm, Tenhult (SE); Patrik Strand, Bankeryd (SE)

(21) Appl. No.: 17/613,244

(22) PCT Filed: Apr. 29, 2020
(86) PCT No.: PCT/SE2020/050432

§ 371 Date: Nov. 22, 2021

(30) Foreign Application Priority Data
May 27, 2019 (SE) 1950626-0

(51) Int. Cl. A47F 9/04; B65G 47/244; B65G 43/10

(52) U.S. Cl. CPC A47F 9/04; B65G 43/10; B65G 47/2445

(57) ABSTRACT

A conveyor system for transporting articles in a checkout counter is provided. The system comprises a first conveyor station (12), and an article positioning conveyor station (14) being arranged in series with the first conveyor station (12). The article positioning conveyor station (14) comprises at least a first and a second conveyor unit (16a, 16b) arranged in parallel with each other in the longitudinal direction, and wherein the first conveyor unit (16a) is operated at a different speed and/or direction than the second conveyor unit (16b).

### TECHNICAL FIELD

The present invention relates to a conveyor system for transporting articles in a checkout counter as well as to a checkout counter comprising such conveyor system.

### BACKGROUND

Today's store may have either manual, semi- and/or fully automatic checkout systems. In a manual checkout system, a checkout operator handles each article manually and makes sure that the article is associated with the correct pricing at checkout for payment by the customer. This is traditionally done either by scanning a barcode attached to the article, manually inputting the PLU-code, manually inputting the price or a combination of those. In either case a conveyor system is often provided for transporting the articles from the area of the customer to the area of the checkout operator. A conveyor system normally includes a conveyor, for example an endless belt which is driven by a pair of rollers. When a customer positions an article on the conveyor it is automatically transported to the operator. A second belt is often provided for further transporting the articles away from the operator and into a packing area. In order to improve the working conditions for the operator it is beneficial if the articles are laying still on the conveyor belts, are arranged with a predetermine distance from each other and being close to the operator.

Semi- or fully automatic checkout counters are becoming an interesting alternative for retail stores and supermarkets. Such checkout counters provide robust and easy identification and handling of articles and they normally include different components for identifying the article accurately. Semi- and fully automatic checkout systems may also comprise a conveyor system for transporting the articles from the area of the customer to an identification area where the articles are partly or fully automatically identified. When a customer positions an article on the belt it is automatically transported to the identification area, and may thereafter be transported into a packing area.

Automatic- and semi-automatic checkout counters must be able to identify many different articles, such as food products, hygiene articles, etc. being of different sizes and shapes. In order to have a high success in the identification of articles it is beneficial if the articles are laying at rest at the conveyor belts and are arranged with a predetermine distance from each other.

Therefore, there is a need for an improved system for positioning articles, especially when such system is used in automatic checkout counters having a conveyor system.

### SUMMARY

Accordingly, the present invention preferably seeks to mitigate, alleviate or eliminate one or more of the above-identified deficiencies in the art and disadvantages singly or in any combination and solves at least the above-mentioned problems by providing. An idea of the present invention is to provide a conveyor system for various articles, wherein the conveyor system ensures that the articles are aligned and separated from each other such that a sensor system, which may be fixed relative the conveyor system, can identify the articles accurately. More preferably, an idea of the present invention is to provide a conveyor system that prevents or at least migrates the problem of having rolling articles on the conveyor.

In a first aspect, a conveyor system for transporting articles in a checkout counter is provided. The system comprises a first conveyor station, and an article positioning conveyor station being arranged in series with the first conveyor station. The article positioning conveyor station comprises at least a first and a second conveyor unit arranged in parallel with each other in the longitudinal direction, and wherein the first conveyor unit is operated at a different speed and/or direction than the second conveyor unit.

The first and second conveyor units may each comprise at least one conveyor.

The conveyor may be a conveyor belt and/or a roller.

In one embodiment, the first conveyor unit and the second conveyor unit each comprises at least one belt conveyor.

The first conveyor station may comprise a loading conveyor on which articles may be placed by a customer. The first conveyor station may be arranged upstream, i.e. before, the article positioning conveyor station.

In one alternative embodiment, the first conveyor station comprises a weight conveyor comprising at least one weight sensor. The first conveyor station may be arranged upstream or downstream the article positioning conveyor station.

In one embodiment, the article positioning conveyor station comprises at least one weight sensor.

The conveyor system may further comprise a third conveyor station. The third conveyor station may comprise a weight conveyor comprising at least one weight sensor. In one embodiment, the third conveyor station is arranged in series with the first conveyor station and the article positioning conveyor station is arranged between the first conveyor station and the third conveyor station.

In one embodiment, the first conveyor unit is operated at a lower speed than the second conveyor unit of the article positioning conveyor station. In an alternative embodiment, the first conveyor unit is operated at a higher speed than the second conveyor unit.

In one embodiment, the direction of speed of the first conveyor unit and the second conveyor unit is the same.

The first conveyor unit may be operated at a lower speed than the first conveyor station. More specifically, the first conveyor unit may be operated at a higher speed than the second conveyor unit and the first conveyor station may be operated at a lower speed than the first conveyor unit.

If present, the third conveyor station may be operated at the same speed as the first conveyor unit. Alternatively, the third conveyor station may be operated at a lower speed than the first conveyor unit.

In one embodiment, the first conveyor unit and the second conveyor unit are tilted by the same angle.

In one embodiment, the first conveyor station, the article positioning conveyor station and, if present, the third conveyor station are tilted by the same angle.

In an alternative embodiment, the first conveyor station, the article positioning conveyor station and, if present, the third conveyor station are tilted by different angles.

In a second aspect, an automatic checkout counter is provided. The automatic checkout counter comprises a conveyor system of the first aspect.

The automatic checkout counter may further comprise a classification device for identification of articles which are moving along said conveyor system, wherein said classification device comprises at least one weight sensor for weighing the articles.

### BRIEF DESCRIPTION OF THE DRAWINGS

Embodiments of the invention will be described in the following; reference being made to the appended drawings which illustrate non-limiting examples of how the inventive concept can be reduced into practice.

FIGS. 1a-d schematically show top views of an automatic checkout counter according to embodiments of the present invention;

FIGS. 2a-c show top views of a conveyor system according to an embodiment of the present invention, where FIG. 2a shows an article being in a first position, FIG. 2b shows an article being in a second position and FIG. 2c shows an article being in a third position;

FIGS. 3a-c schematically show top views of different embodiments of a conveyor system;

FIGS. 4a-e schematically show top views of different embodiments of a conveyor system;

FIGS. 5a-b schematically show side views of different embodiments of a conveyor system;

FIG. 6 schematically shows a top view of an embodiments of a checkout counter comprising a conveyor system; and

FIG. 7 shows a schematic view of parts of a checkout counter.

### DETAILED DESCRIPTION OF EMBODIMENTS

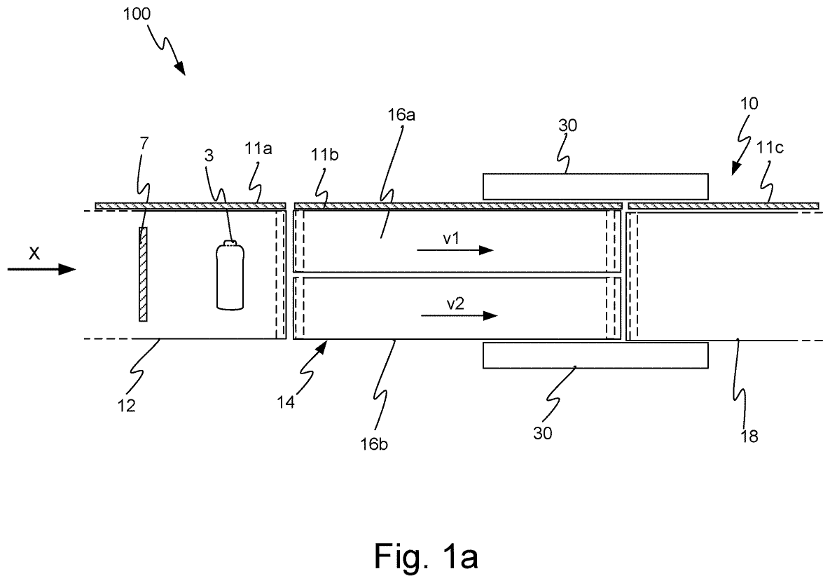

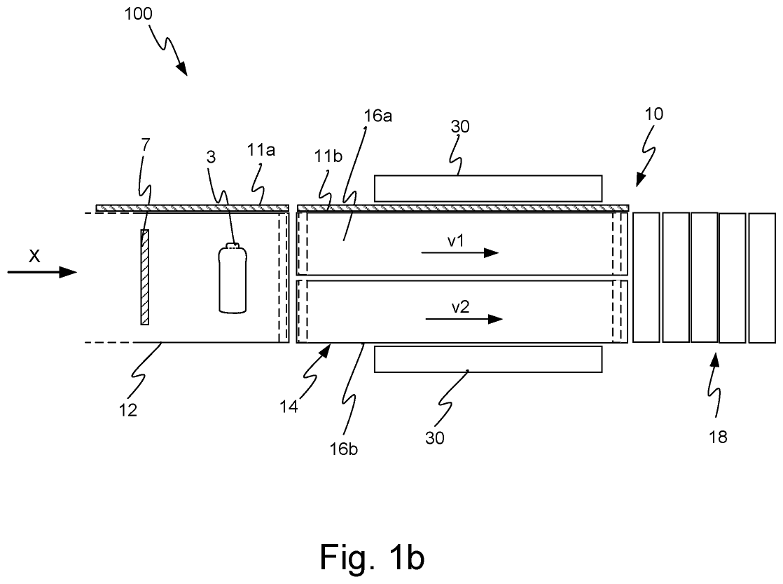

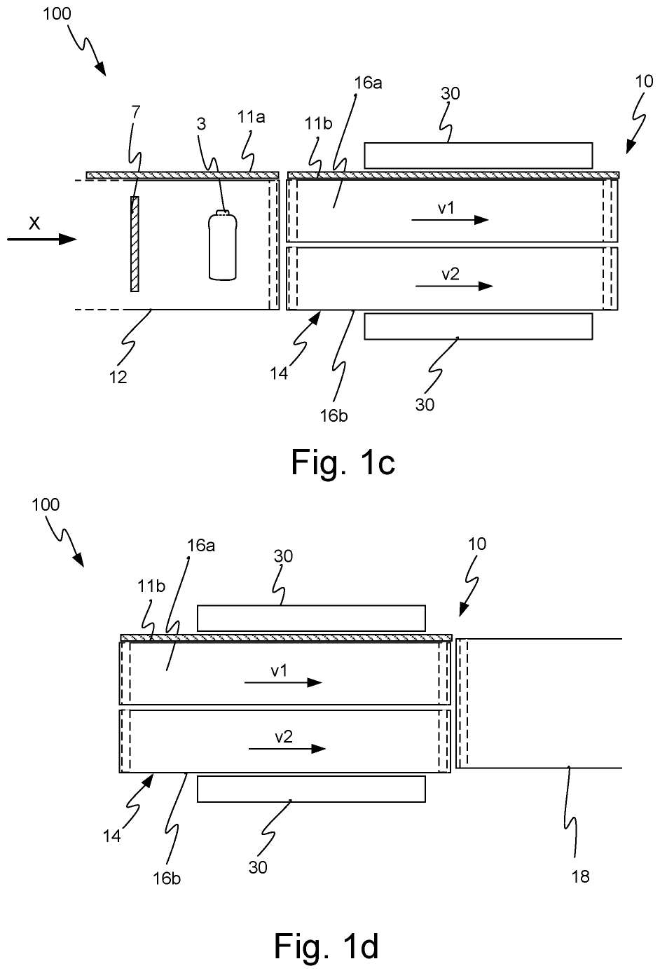

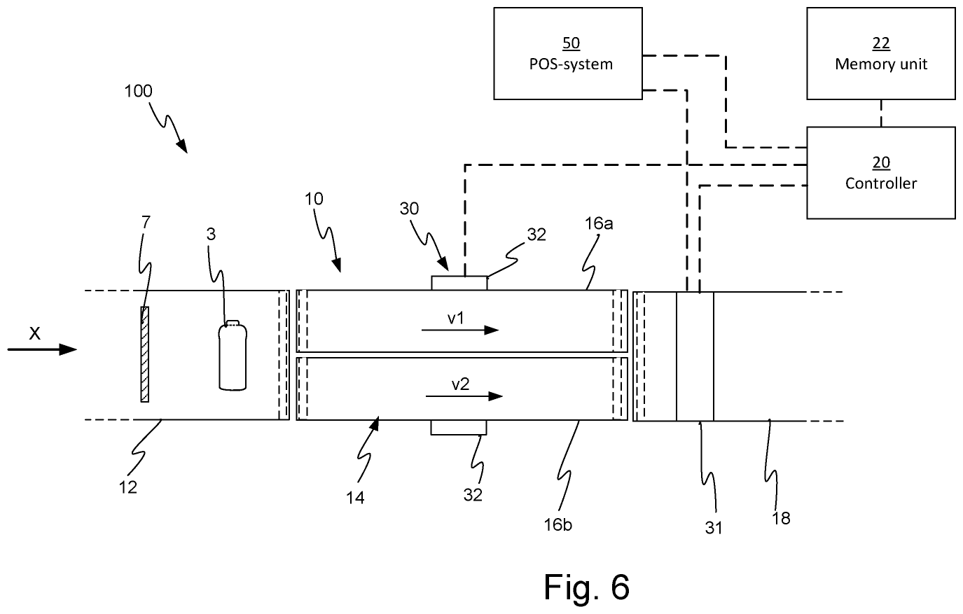

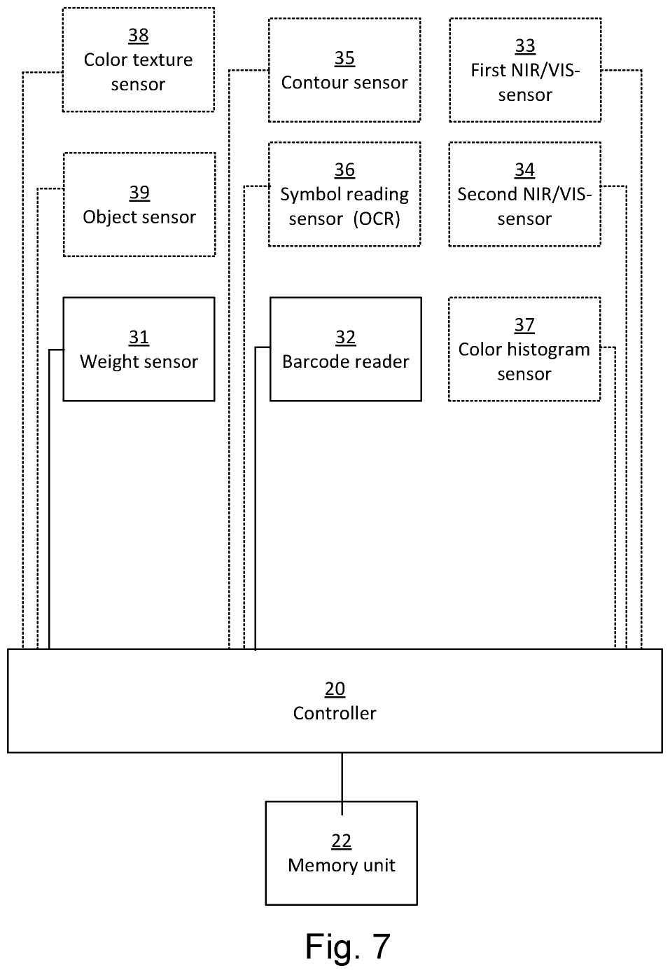

FIGS. 1a-d show a checkout counter 100 comprising a conveyor system 10 for transporting articles 3 from a loading area to a packing area, and a classification system 30 through which articles 3 pass for automatic or semi-automatic identification. The classification device 30 is further described with reference to FIGS. 6 and 7. Although the following description is based on a conveyor system 10 being arranged in an automatic or semi-automatic checkout counter 100, it should be understood that the conveyor system also is applicable to manual checkout counters 100.

In some embodiments, a checkout operator, or store attendant, is positioned somewhere in conjunction to the checkout counter 100 for providing manual input when needed. In other embodiments, no checkout operator is needed.

The checkout counter 100 may further make use of a customer divider bar 7 for separating articles 3 belonging to one customer from the next one in line. In some embodiments, the classification system 30 is able to identify the customer divider bar 7 and thus realize that all articles 3 being associated with a specific customer have been scanned.

The conveyor system 10, comprising one or a plurality of conveyor stations, extends from the loading area, and ensures article transport through the classification system 30 towards a packing area. The direction of motion of the article 3 on the conveyor stations are shown in FIGS. 1a-d by arrow X.

In the embodiment shown in FIG. 1a, the conveyor system 10 comprises a first conveyor station 12, and an article positioning conveyor station 14. The article positioning conveyor station 14 is arranged in series with the first conveyor station 12.

The first conveyor station 12 may comprise a loading conveyor on which articles 3 may be placed by a customer (not shown). In the embodiment shown in FIG. 1a, the first conveyor station 12 is arranged before, i.e. upstream, the article positioning conveyor station 14. However, it should be noted that the first conveyor station 12 may be arranged after, i.e. downstream, the article positioning conveyor station 14 instead, as is shown in FIG. 1d.

In the embodiment shown in FIG. 1a, a third conveyor station 18 is provided in series with the article positioning conveyor station 14. In this embodiment, the article positioning conveyor station 14 is arranged between the first conveyor station 12 and the third conveyor station 18.

The third conveyor station 18 may comprise a weighing conveyor. The weighing conveyor may comprise at least one weight sensor 31.

FIG. 1b shows an alternative embodiment where the third conveyor station 16 comprises a plurality of rollers. In this embodiment, it is preferred if the article positioning conveyor station 14 comprises at least one weight sensor 31.

FIG. 1c shows an embodiment where the conveyor system 10 comprises a first conveyor system 12 hand an article positioning conveyor system 14. Here, the first conveyor system 12 is arranged before the article positioning conveyor system 16. Once the articles have passed the positioning conveyor system 10, the articles may for example be collected by the customer, transported on conveyor belts or rollers, or fall onto a collection area.

FIG. 1d shows an embodiment where the conveyor system 10 comprises a first conveyor system 12 and an article positioning conveyor system 14, and where the first conveyor system 12 is arranged after the article positioning conveyor system 14. Hence, here the articles may be loaded directly onto the article positioning conveyor system 16.

Additionally, although not shown, the conveyor system 10 may comprise a first conveyor system 12, a third conveyor system 18 and an article positioning conveyor system 16, where the third conveyor system 18 is arranged in between the first conveyor system 12 and the article positioning conveyor system 14. Hence, the article positioning conveyor system 14 may be arranged downstream, i.e. below, both the first conveyor system 12 and the third conveyor system 18.

In the following description, the embodiment discussed will comprise a first conveyor system 12, an article positioning conveyor system 14 and a third conveyor system 18, however the following features are applicable to other arrangements of the conveyor system 10.

In one embodiment, the conveyor system 10 may comprise at least one support wall 11. In the embodiment shown in FIGS. 1a-d, the support wall 11 extends along at least one side of the conveyor system 10 in a direction along the conveyors. The support wall 11 may comprise a plurality of wall portions 11a-c, for example one or two wall portions along the loading conveyor, one or two wall portions along the weighing conveyor, and one or two wall portions along the article positioning conveyor station 14. However, it should be noted that the support wall portion shall not be placed in between the at least two conveyor units 16a, 16b. The height of the support wall may vary along the different conveyor. The height is preferably such that it reduces the risk that articles will fall of the conveyor system 10.

In the embodiment shown in FIGS. 1a-d, the article positioning conveyor station 14 comprises two conveyor unit 16a, 16b. The two conveyor units 16a, 16b are arranged in parallel with each other, in the longitudinal direction. Hence, the two conveyor units are arranged parallel in the direction of movement of the articles. In some embodiments, the two conveyor units 16a, 16b may also be seen as being arranged in the same horizontal plane.

As will be described more in detail later, the conveyor units may each comprise one single conveyor or a plurality of conveyors. Moreover, the conveyors may be conveyor belts or in the form of rollers.

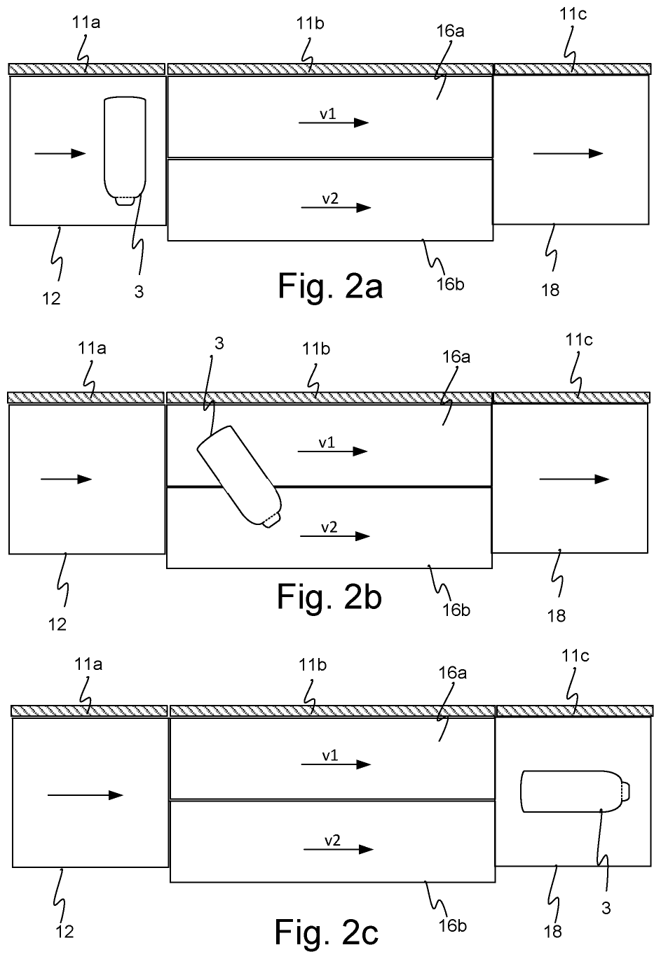

Customers generally places elongated rotatable objects, such as for example bottles and cans, across the width of the loading conveyor 12 (i.e. not parallel with the movement of the conveyor system). Elongated articles having round shaped cross-sections tend to roll when accelerated, and there is thus a risk that the article rolls of the conveyor band in an unsuitable way. By having at least two parallel conveyor units 16a, 16b operated at different speeds, the article will rotate so that it is more in parallel with the conveyor movement. The rotation of the article is illustrated in FIGS. 2a-c, where it will be described further.

The difference in speed of the at least two conveyor units 16a, 16b may be around 20-50%, and more preferably the difference in speed is around 30% between the first and the second conveyor units 16a, 16b.

In one embodiment, the first conveyor unit 16a is operated at a lower speed than the second conveyor unit 16b. In one embodiment, the first conveyor unit 16a is moving at a speed of 0.25-0.50 m/s, and preferably a speed of approximately 0.40 m/s. The second conveyor unit 16b is moving at a speed of 0.40-0.65 m/s, and preferably a speed of approximately 0.55 m/s. The difference in speed could also be a difference in direction, hence for example the first conveyor unit 16a may be driven at a speed of 0.55 m/s where the second conveyor unit 16b is driven at a speed of −0.55 m/s.

In one embodiment, the first conveyor unit 16a is arranged close to the support wall 11 and the second conveyor unit 16b is arranged further away from the support wall 11. However, in an alternative embodiment the second conveyor unit 16b is arranged close to the support wall and the first conveyor unit 16a is arranged further away.

The velocity of the article positioning conveyor station 14 have herein been described as a constant speed. However, in some embodiments the at least one of the conveyor units 16a, 16b of the article positioning conveyor station 14 could be configured to have a gradual increase in velocity.

In one embodiment, the at least two conveyor units 16a, 16b of the article positioning conveyor station are driven by one single motor. This can be true even if the number of conveyor units are increased. The difference in speed of the at least two conveyor units 16a, 16b of the article positioning conveyor station are made possible by for example having different dimeters of the rollers forming part of the conveyor units.

In an alternative embodiment, the at least two conveyor units 16a, 16b of the article positioning conveyor station are driven by a plurality of motors. For example, if the article positioning conveyor station 14 comprises two conveyor units 16a, 16b each of the conveyor units are driven by a separate motor.

In one embodiment, where the article positioning conveyor station 14 comprises four conveyor units, each conveyor unit may then be driven by a separate motor. In an alternative embodiment, the four conveyor units of the article positioning conveyor station 14 are driven by two motors, where each motor drives two conveyors units each. In an alternative embodiment, the four conveyors are driven by a single motor.

The use of the conveyor system will now be described with reference to FIGS. 2a-c. In FIG. 2a, a customer has placed the article 3, here illustrated as a bottle, in a position where the elongated portion of the article is perpendicular to the movement direction of the conveyor system. There is thus a great risk that the article will start to roll.

In FIG. 2b, the article 3 has entered the article positioning conveyor station 14. The difference in speed in the first and the second conveyor unit 16a, 16b causes the article 3 to rotate.

FIG. 2c illustrates the situation where the article 3 has been rotated by the article positioning conveyor station 14 and been passed on to the weighing conveyor 18. Due to the placement of the article 3, it is less likely to roll away on the conveyor.

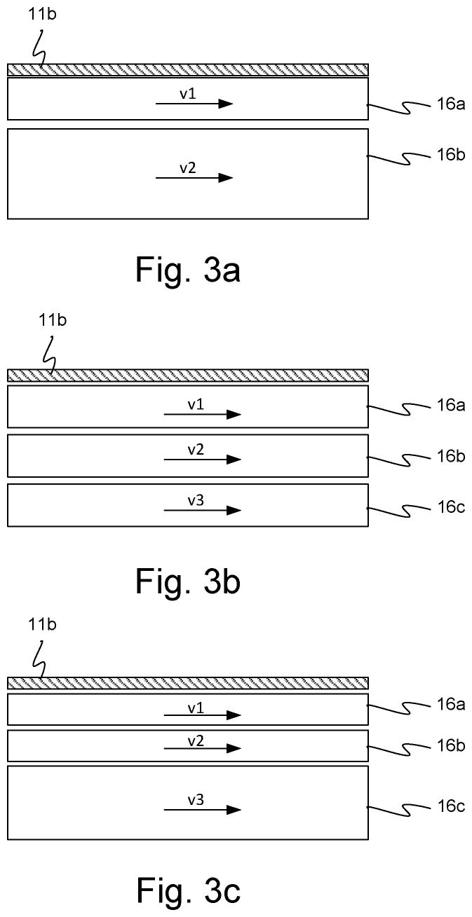

In the embodiment shown in FIGS. 1 and 2, the article positioning conveyor station 14 comprises two conveyor units having the same width. However, the number of conveyor units may be three, four, five or any number of conveyor units larger than two. Additionally, each conveyor unit may comprise a plurality of conveyors. Moreover, the width of the conveyor units of the article positioning conveyor station may vary. This is schematically illustrated in FIGS. 3a-c.

In FIG. 3a, the article positioning conveyor station 14 comprises two conveyor units 16a, 16b, each unit comprising one conveyor. One of the conveyors have a smaller width than the other. The width of the first conveyor 16a may for example be a third of the width of the second conveyor 16b. However, as should be understood by a person skilled in the art, other width ratios may be possible. The operating speed of the first conveyor 16a is denoted v1 and the operating speed of the second conveyor 16b is denoted v2. The speed v1 is different from the speed v2. Hence, v1 may have a higher speed than v2 or a lower speed than v2. It should be noted that that the speed could be negative, hence be driven in the opposite direction. The speed is considered to be different if one speed is negative and one speed is positive, i.e. the speeds are different if the direction of movements is different.

In FIG. 3b, the article positioning conveyor station 14 comprises three conveyor units 16a, 16b, 16c, each conveyor unit comprising one conveyor The operating speed of the first conveyor 16a is denoted v1, the operating speed of the second conveyor 16b is denoted v2 and the operating speed of the third conveyor 16c is denoted v3. The speed v1 may be the same as v2, if v3 is of a different speed. Moreover, the speed of v1 may be the same as v3 if v2 is of a different speed, and/or the speed of v2 may be the same as v3 if v1 is of a different speed. Preferably, all three conveyors 16a, 16b, 16c have different operating speeds v1, v2, v3. Different configurations are possible, for example the speed v1 of the first conveyor 16a may be highest and the speed of the third conveyor 16c may be lowest. Alternatively, the speed v1 of the first conveyor 16a may be lowest and the speed of the third conveyor 16c may be highest.

FIG. 3c illustrates an article positioning conveyor station 14 that comprises three conveyor units 16a, 16b, 16c, each conveyor unit comprising one conveyor. Two of the conveyors are of the same width and the third conveyor are of a different width. In this embodiment, the conveyor 16c having the largest width is arranged furthest away from the support wall 11. Hence, here the conveyor 16a having the smallest width is arranged closest to the support wall 11. However, as should be understood by a person skilled in the art, other configurations within the scope of the invention.

In one embodiment, where the article positioning conveyor station 14 comprises more than two conveyor units, at least one of the conveyor units may be operated in a different direction than the other conveyor units. For example, in an embodiment where the article positioning conveyor station 14 comprises four conveyors, one or two of the conveyors may be driven in a direction of motion that is opposite the direction of motion denoted as v1, v2, v3.

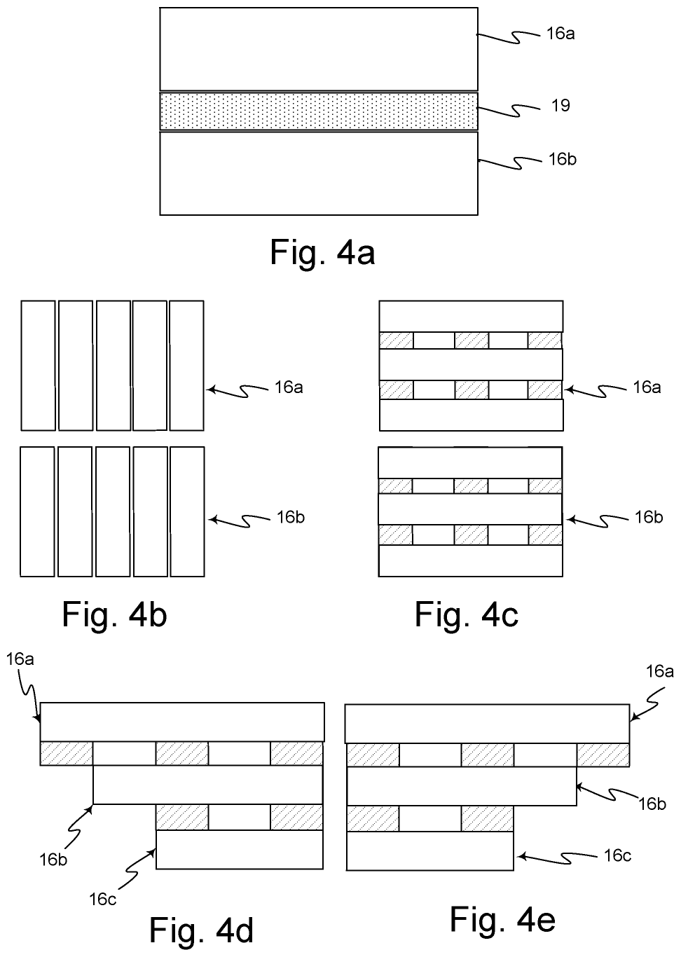

FIGS. 4a-c show different configurations of the conveyor units. In one embodiment, as shown in FIG. 4a, the article positioning conveyor station 14 comprises at least two conveyor units 16a, 16b. Each conveyor unit comprises one conveyor, being belt conveyors (or conveyor belts). The belts are preferably endless belts.

The two conveyors of the article positioning conveyor station 14 may be separated from each other by one or more plate(s) 19. The plate 19 may be a metal plate. The width of the plate 19 is preferably smaller than the width of the conveyor units 16a, 16b. The plate 19 is preferably flat, so that it allows the article to move on either on the first and/or second conveyor units 16a, 16b. Hence, the plate 19 is such that it does not delimit the movement of the article being arranged on the article positioning conveyor station 14.

In an embodiment where the article positioning conveyor station 14 comprises a plurality of conveyor units, a plurality of plates 19 may separate the conveyor units from each other. In such an embodiment, the width of the plates 19 may differ between the different conveyor units.

In an alternative embodiment, as shown in FIG. 4b, the article positioning conveyor station 14 comprises at least two conveyor units 16a, 16b. Each conveyor unit 16a, 16b comprises a plurality of rollers. These are arranged in parallel. The article positioning conveyor station 14 may thus be seen as having two conveyor units 16a, 16b each comprising a plurality of conveyors in the form of rollers. In the embodiment shown in FIG. 4b, the article positioning conveyor station 14 comprises ten rollers, five rollers for each conveyor unit 16a, 16b. However, as should be understood any number of rollers could be used, such as two, three, four, five, six etc.

In yet one further embodiment, as shown in FIG. 4c, the article positioning conveyor station 14 comprises at least two conveyor units 16a, 16b, each unit being in the form of two or more driven rollers which are connected by several endless strips. Hence, the strips form a surface onto which the article may rest upon, whereby such configuration allows the rollers to be separated from each other.

FIGS. 4d and 4e shows similar embodiments to that of FIG. 4c. However, in FIG. 4d the article positioning conveyor station 14 comprises three conveyor units 16a, 16b, 16c, each being in the form of driven rollers, which are connected by several endless strips. Hence, one conveyor unit comprises an endless strip. In the embodiment shown in FIG. 4d, the strips 16a-c are arranged with different starting points but with the same end. In the embodiment shown in FIG. 4e, the strips are instead arranged with different end points but the same starting points.

In yet one embodiment, although not shown, the lengths of the strips are the same, but the starting and end points of the strips differ from each other.

In some embodiment, the article positioning conveyor station 14 also acts as an article separator. Customers generally tend to place articles 3 very close to each other on the loading conveyor 12, or even in a stacked manner. In order to separate the articles 3 from each other longitudinally, i.e. in the direction of movement, the loading conveyor may be operated at a lower speed than the lowest speed of the article positioning conveyor station 14. The article positioning conveyor station 14 may thus be arranged so as to ensure that the articles 3 are separated from each other longitudinally, i.e. in the direction of movement. For this, the conveyors 16a, 16b of the article positioning conveyor station 14 may be operated at a higher speed than the loading conveyor 12.

In a preferred embodiment, the loading conveyor 14 is moving at a speed of 0.05-0.25 m/s, and preferably at a speed of 0.11 m/s.

In one embodiment, the weighing conveyor 18 may be configured to move at the same speed as the conveyor unit 16a, 16b of the article positioning conveyor station 14 having the lowest speed. In other embodiments, the weighing conveyor 18 is configured to move at the same speed as any one of the conveyor units 16a, 16b of the article positioning conveyor station 14. However, it should be noted that the weighing conveyor 18 could be operated at other speeds as well.

An accurate identification of the articles by means of the classification device 30 benefits not only by a longitudinal separation, but also by having the articles aligned in a lateral direction, i.e. in a direction perpendicular to the longitudinal axis of the conveyor system 20. This is due to the fact that the classification device 30 may comprise one or more identification sensors which preferably have a fixed position relative the article positioning conveyor station 14.

In one embodiment, the loading conveyor 12, the article positioning conveyor station 14 and/or weighing conveyor 18 are tilted in the lateral direction with respect to a horizontal plane. This makes sure that the articles 3 being loaded onto the conveyor system will be are aligned laterally.

In a preferred embodiment, the conveyor system 10 is tilted with the same angle, hence the loading conveyor 12, the article positioning conveyor station 14 and the weighing conveyor 18 are all tilted by the same angle. The tilting angle may for example be within the range of 5-25°, and more preferably 10°. In other embodiments, the loading conveyor 12, the article positioning conveyor station 14 and the weighing conveyor 18 are tilted by different angles. In that case, it is preferred if the tilting angle of the loading conveyor 12 is higher than the titling angle of the article positioning conveyor station 14.

In an alternative embodiment, the loading conveyor 12 is tilted, while the article positioning conveyor station 14 and/or weighing conveyor 18 are aligned in parallel with a horizontal plan, i.e. not tilted.

In yet an alternative embodiment, the loading conveyor 12, the weighing conveyor 18 and the article positioning conveyor station 14 are tilted by different angles.

By tilting at least the loading conveyor 12 the articles are sliding downwards by means of gravity until they reach one lateral side 13, the side to which the conveyor system 20 is tilted downwards, of the loading conveyor 12. A support wall or a sliding surface may be provided at the lateral side 13 for preventing articles from falling out from the conveyor 12. The sliding surface (or support wall) may be tilted 90° relative the loading conveyor 12. The sliding surface is preferably made of Teflon, or other similar low-friction material. Once the articles are aligned in the transversal direction, the lateral position will be maintained throughout the conveyor system 20.

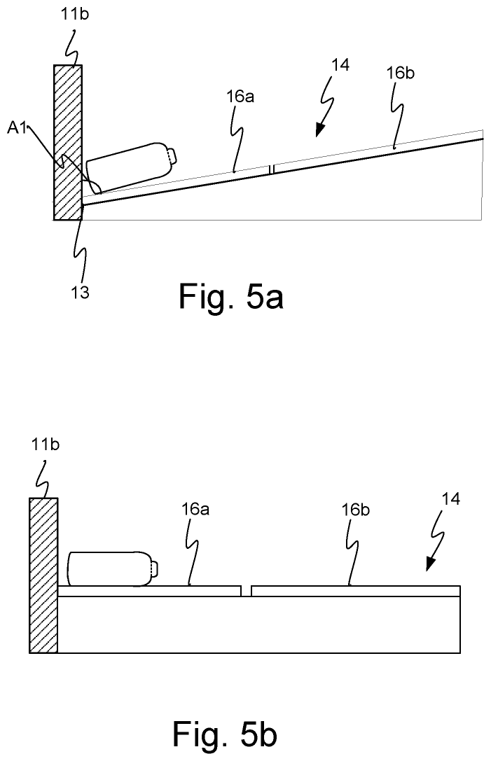

FIG. 5a is a side view of an article positioning conveyor station 14 that is tilted with an angle A1 in the in the lateral direction with respect to a horizontal plane. As can be seen in FIG. 5a, it is preferred if the tilt of the conveyors 16a, 16b is such that the items will be rolling down towards the support wall 11b, if a such support wall 11b is present. Hence, the center point of the second conveyor unit 16b is arranged higher than the center point of the first conveyor unit 16a.

FIG. 5b is a side view of an article positioning conveyor station 14 where the conveyor units 16a, 16b are arranged in the same horizontal plane.

Although not shown, the conveyors of the article positioning conveyor station 14 may be tilted by different angles.

### System

Now turning to FIG. 6, illustrating the conveyor system 10 being arranged in a checkout counter 100. The classification system 30 comprises a weight sensor 31 for weighing the articles 3. The classification system 30 may further comprise a barcode reading system 32 for scanning articles 3 and for identifying articles 3 being provided with a readable barcode and a controller 20. Additionally, or alternatively, as will be described more with reference to FIG. 7, other sensors may be present in the classification sensor 30.

In some embodiments, the controller 20 is in operative communication with a display (not shown), wherein the display either is arranged as part of the classification system as a part of a separate POS-system.

The controller 20 is further configured to control the operation of the conveyor system 10. The controller 20 is preferably configured to control the speed of the loading conveyor 12, weighing conveyor 18 and the article positioning conveyor station 14.

As an example, a rounded article, such as a melon, may be subject to identification by the classification device 30. Due to its round shape it will most likely not lay still as it is accelerated by the article positioning conveyor station 14. Hence the movement will not be accepted by the weighing conveyor 18 when weighing the article. The controller thus detects the movement, e.g. by a camera, whereby the controller stops the driving mechanisms of the weighing conveyor 18. In order to ensure that only one article at the time is passing through the classification device 30 the controller 20 may also stop the movement of the loading conveyor and/or the article positioning conveyor station 14. Once the article has stopped its movement, the scale may measure an accurate weight and the controller 20 may then be configured to start the loading conveyor 12, weighing conveyor 18 and the article positioning conveyor station 14.

In one embodiment, the weight sensor 31 comprises one conveyor scale comprising one conveyor part and one weight unit connected thereto which automatically conveys the article 3, weighs it and transmit the information of the weight to a database in the controller 20. In this way the need of manual transport of the article 3 over the weight unit is removed. In some embodiments, one or several sensors may be connected to the checkout counter 100 for controlling the conveyor scale. The weight sensor 31 is preferably arranged in the weighing conveyor 18. The weighing conveyor 18 may be in the form of a conveyor belt.

In one embodiment, the weight of the article 3 is subsequently used by the controller 20 together with the article identity, which is determined either by the classification system, for example using the barcode reading system 32, or manually by the checkout operator 5, for verifying that the article on the weight sensor 31 corresponds with the weight information stored in the system. In this embodiment, the weight sensor 31 is used as control measurement.

In one embodiment, the weight sensor 31 is connected both to the controller 20 and a POS-system 50. The POS-system 50 performs a certified weighing. Certified weighing might be required in some environments. The certified weighing may have a greater accuracy than the weight information gathered by the controller 20. For articles not having a barcode and where the price of the article is dependent on its weight, the POS-system will use the certified weighing to determine the price of the article. Hence, in this embodiment and for articles whose price is dependent on its weight, the information transmitted by the controller 20 to the POS-system 50 does not comprise information of the weight and/or price of the article.

In the situation where the controller 20 finds a barcode on an article where its price is dependent on its weight, the weight will be transmitted as a part of the barcode.

In yet one embodiment, the weight sensor 31 is arranged to perform the certified weighing without the need of a POS-system. The information transmitted to the POS-system 50 from the controller 20 will, for articles whose price is dependent on its weight, comprise information relating to both the price and/or the weight of the article.

The barcode reading system 32 is arranged in conjunction to the loading conveyor 12, the article positioning conveyor station 14 and/or the weight conveyor 18. The barcode reading system 32 scans all articles 3 and identifies those articles 3 being provided with a readable barcode. As will be described later, articles 3 having no barcode or a defect barcode will be identified by other means. The barcode reading system 32 may comprise at least one camera for providing still or moving images. The barcode reading system 32 may be connected to an image processing unit, possibly realized by means of the controller 20, which image processing unit allows the read barcode to be checked against pre-stored article identities.

The barcode reading system 32 may further comprise a second camera and possibly several cameras to be able to see the article 3 from different angles for achieving the highest possible reliability when detecting the barcode. The other camera, and if applicable a further camera/cameras, is/are arranged to record an image or images which will be used by the image processing unit for analysis of a barcode reading. It is preferred if the barcode can be read regardless of the position of the barcode on the article 3, or the position of the article 3 on the conveyor system 10. Preferably, the barcode reading system 32 comprises at least four cameras, arranged above, below and on both sides of the conveyor system 10.

The classification system may additionally, or alternatively to the barcode reading system 32, comprise further identification sensors. This is illustrated in FIG. 7. The system 30 may comprise one or several of: a contour sensor 35 and/or a symbol reading sensor 36 which uses optical character recognition and (machine) text interpretation and/or a color texture sensor 38 and/or a color histogram sensor 37 and/or a first spectroscopy sensor 33, and/or a second spectroscopy sensor 34 and/or an object sensor 39. The symbol reading sensor 36 is from hereon called OCR which is a generally known abbreviation of the English expression “Optical Character Recognition”.

The first spectroscopy sensor 33 may be an infrared spectroscopy sensor, from hereon denoted as a NIR sensor which is detecting wavelengths from approximately 780 nm to 2500 nm. The memory unit 22 comprises one or several first signatures created by the first NIR sensor 33 or another NIR sensor 34, each of which first signatures is connected to a corresponding article identity. The first signatures may be created directly at the checkout counter by using the first NIR sensor 33, a second NIR sensor 34, or by storing signatures created by a NIR sensor not connected to the checkout counter in said memory.

When a NIR sensor 33, 34 is used on a certain kind of article, e.g. a specific type of apple, a first signature will be received which may be coupled to the article and which may be denoted as a specific article identity in the memory unit 22, like e.g. the name of the article. Each type of article creates a unique first signature which may be coupled to the identity of the article. The first NIR sensor 33 is arranged to create a second signature connected to the article when an article is placed before, on or after the weight sensor 31. The controller 20 is subsequently arranged to compare the second signature to the first signature in order to identify the article as an existing article identity in the memory unit 22.

The second spectroscopy sensor 34 may be a VIS sensor 33, 34. The VIS sensor 33, 34 is a spectrometer comprising a light source and a VIS camera, from hereon called a VIS sensor 33, 34, the VIS sensor 33, 34 is detecting wavelengths from approximately 200 nm to 1100 nm. The spectrum thus overlaps the wavelengths of visual light which extends from 400 nm to 660 nm. Experiments have shown that, at the device according to the invention, the classification device comprising a color texture sensor 38 and/or a color histogram sensor 37 and/or a VIS sensor 33, 34 does not operate satisfactory when the VIS sensor 33, 34 is operating in the complete frequency interval 200 nm-1100 nm since there is a conflict between the color sensors 37, 38 and the VIS sensor 33, 34 in the interval of visual light, i.e. between 400 nm and 660 nm.

The VIS sensor 33, 34 is therefore active in the intervals between 200 nm and 400 nm and between 660 nm and 1100 nm when it is combined with the color texture sensor 38 and/or the color histogram sensor 37. If the color texture sensor 38 and the color histogram sensor 37 are disconnected the VIS sensor 33, 34 may however operate in the complete frequency interval between 200 nm and 1100 nm since there is no conflict. The controller 20 is programmed to control the sensors to achieve optimal efficiency of the classification

The symbol reading sensor 36 is connected to a computer/image processing unit which uses an algorithm using information from images from the existing camera or cameras of the device. For articles, which substantially can be unambiguously identified by means of symbol reading, it will be sufficient if the symbol reading sensor 36, OCR, identifies a symbol and/or a text which then unambiguously identifies the article. Examples of articles which may be identified by only using a symbol reading sensor 36, OCR, are pre-packaged packages where the customer is not required to perform any procedure, such as refilling or any other procedure. Example of articles where it is not enough with the symbol reading sensor 36, are some bulk articles where the quantity of the article, i.e. weight, is not known. Further properties of the article may be necessary and may require symbol reading and/or weight and/or color histogram and/or color texture and/or contour. It shall be mentioned that “contour” is defined as a two dimensional projection of a three dimensional object.

Certain articles are thus more difficult to identify than others and depending on the article one or several of the included sensors of the classification device are required.

The contour sensor 35 comprises a camera for providing still or moving images and may preferably be a linear camera which reads a horizontally projected surface or a linear camera in combination with an object sensor 39 which consists of a vertical light curtain for reading the vertical projection. The contour sensor 35 is connected to an image processing unit where the contour, i.e. a two dimensional projection of a three dimensional object, is checked against the properties in the database.

The symbol reading sensor 36 comprises a camera for providing still or moving images. The symbol reading sensor 36 is connected to an image processing unit where the symbol is checked against the properties in the database.

The color texture sensor 38 comprises a camera for providing still and moving image. The color texture sensor 38 is connected to an image processing unit where the color texture is checked against the properties in the database. The image processing unit comprises an algorithm which calculates where a certain color is present in the image. One common algorithm is “Weibull color texture algorithm”, but other algorithms may also be considered.

The color histogram sensor 37 comprises a camera for providing still and moving pictures. The color ratio in the image is usually illustrated by means of a representation, a so-called histogram. A histogram is generated by examination of all pixels of the image, and the number of pixels having a specific color value are summarized.

The embodiment with several sensors such as described above, are designed on a number of combinations comprising a partial set of sensors, where it will be sufficient that one of the combinations provides a possible article identity. The combinations may be predetermined or arbitrarily selected. Sensors may be switch on, i.e. be activated, in sequences in order to find beneficial combinations or a partial set of sensors or all sensors may be active until one of the combinations provide a possible article identity.

The article identity may be determined by means of checking a database comprising properties of a number of articles. Example of properties may include weight, size, color, shape, contour and/or marking.

The sensors may preferably be placed completely or partly in a tunnel shaped construction which shields a part of the conveyor and therefore improves the security by preventing unauthorized people from the possibility to affect the classification process.

It should be appreciated that even though numerous characteristics and advantages of the present invention have been set forth in the foregoing description, together with details of the structure and function of the invention, the description is only illustrative and changes may be made in detail, especially in matters of shape, size and arrangement of parts within the scope of the invention to the full extent indicated by the appended claims.

1. A conveyor system for transporting articles in a checkout counter, comprising:
a first conveyor station (12), and
an article positioning conveyor station (14) being arranged in series with the first conveyor station (12),
characterized in that the article positioning conveyor station (14) comprises at least a first and a second conveyor unit (16a, 16b) arranged in parallel with each other in the longitudinal direction, and wherein the first conveyor unit (16a) is operated at a different speed and/or direction than the second conveyor unit (16b).

2. The conveyor system according to claim 1, wherein the first and second conveyor units (16a, 16b) each comprises at least one conveyor.

3. The conveyor system according to claim 2, wherein at least one conveyor is a conveyor belt.

4. The conveyor system according to claim 1, wherein the first conveyor station (12) comprises a loading conveyor on which articles may be placed by a customer.

5. The conveyor system according to claim 4, wherein the first conveyor station (12) is arranged upstream the article positioning conveyor station (14).

6. The conveyor system according to claim 1, wherein the article positioning conveyor station (14) comprises at least one weight sensor (31).

7. The conveyor system according to claim 1, wherein the first conveyor station (12) comprises a weight conveyor comprising at least one weight sensor (31).

8. The conveyor system according to claim 7, wherein first conveyor station (12) is arranged upstream or downstream the article positioning conveyor station (14).

9. The conveyor system according to claim 1, wherein the conveyor system further comprises a third conveyor station (18), wherein the third conveyor station (18) is arranged in series with the first conveyor station (12) and the article positioning conveyor station (14) in a way such that the article positioning conveyor station (14) is arranged between the first conveyor station (12) and the third conveyor station (18).

10. The conveyor system according to claim 1, wherein the first conveyor unit (16a) is operated at a lower speed than the second conveyor unit (16b) of the article positioning conveyor station (14).

11. The conveyor system according to claim 1, wherein the first conveyor unit (16a) is operated at a higher speed than the second conveyor unit (16b) of the article positioning conveyor station (14).

12. The conveyor system according to claim 1, wherein the first conveyor unit (16a) and the second conveyor unit (16b) are tilted by the same angle.

13. The conveyor system according to claim 1, wherein the first conveyor system (12) and the article positioning conveyor system (14) are tilted by the same angle.

14. The conveyor system according to claim 1, wherein the first conveyor system (12) and the article positioning conveyor system (14) are tilted by different angles.

15. The conveyor system (10) of claim 1 wherein the conveyor system is included in automatic checkout counter (100).

16. The conveyor system (10) according to claim 15, wherein the automatic checkout counter further comprises a classification device (30) for identification of articles which are moving along said conveyor system (10), wherein said classification device (30) comprises at least one weight sensor (31) for weighing the articles.
